(19) United States
(12) Patent Application Publication
(10) Pub. No.: US 2006/0070533 A1
(43) Pub. Date: Apr. 6, 2006

(54) Refuse compactor

(76) Inventors: Daniel Paul Silcock, Dowerglen (ZA); Kieron Mark Geoghegan, Bedfordview (ZA)

Correspondence Address: FISH & RICHARDSON P.C., P.O. BOX 1022, MINNEAPOLIS, MN, 55440-1022, US

(21) Appl. No.: 10/523,626

(22) PCT Filed: Aug. 5, 2003
(86) PCT No.: PCT/IB03/03147

§ 371 Date: Feb. 4, 2005

(30) Foreign Application Priority Data
Aug. 5, 2002 (ZA) 2002/6213

(51) Int. Cl. B30B 15/00

(52) U.S. Cl. 100/100

(57) ABSTRACT

This invention relates to apparatus for use in compacting refuse and includes at least one roller secured to a chassis having a coupling for releasably securing the chassis to a boom of a front-end loader. The invention also extends to a cleat for a roller which is formed from two halves offset from each other along a circumference of the roller.

### FIELD OF THE INVENTION

This invention relates to apparatus for use in compacting refuse and extends to a cleat for a compacting roller.

### BACKGROUND TO THE INVENTION

It is an important aspect of waste disposal that refuse in tips be properly compacted. An effective machine exists for this purpose which is essentially a heavy vehicle having four wheels each in the form of a steel roller with a plurality of cleats thereon. These are also known as “Caron wheels”. The cleats not only serve to provide traction but also to the shear the refuse into smaller pieces. The major drawback of such machines is their cost which makes them difficult to afford. It is particularly not cost effective for smaller operators to make use of such machines, where the volume of waste to be disposed of is relatively small

Rollers which are towed behind vehicles are thus frequently used. Front-end loaders, sometimes referred to as wheel loaders, are often used to tow the rollers as these vehicles are widely used on tips to move refuse. However, such rollers are not very effective simply because they do not have sufficient weight. They are also tend to be cumbersome as they are difficult to manoeuvre and hence cannot be used in many situations.

### OBJECT OF THE INVENTION

It is an object of this invention to provide a refuse compactor which will at least partially alleviate some of the abovementioned problems. It is a further object of this invention to provide an improved cleat for a compacting roller. It is a still further object of this invention to provide a method for compacting refuse which will at least partially alleviate some of the abovementioned problems.

### SUMMARY OF THE INVENTION

In accordance with this invention there is provided a refuse compactor comprising at least one roller secured to a chassis having a coupling for releasably securing the chassis to a boom of a front-end loader.

Further features on the invention provide for the compactor to include a pair of independently rotatable rollers; for the rollers to be secured to a central axle; for each roller to have a plurality of cleats thereon; for the cleats to be formed in rows about the circumference of each roller; for each cleat to be formed from two halves offset from each other along a circumference of the roller; for the edges of each half of each cleat to taper to a flat end; for each half of each cleat to extend from a circumferential flange on the roller; and for the flanges to be spaced apart.

Yet further features of the invention provide for the chassis to be at least partly rotatable with respect to the coupling; and for the coupling to be rotatably secured to a shaft extending across the chassis intermediate the rollers.

Still further features of the invention provide for a stabiliser mechanism to restrict rotation of the chassis with respect to the coupling; for the stabiliser mechanism to provide a downward bias on the chassis on either side of the shaft; for the stabiliser mechanism to provide stops to limit the extent of rotation of the chassis with respect to the coupling; and for the stabiliser mechanism to include at least one lock to secure the chassis and coupling against relative rotation.

Further features of the invention provide for at least one scraper to extend from the chassis between each row of cleats on each roller; preferably for a pair of scrapers to extend from opposite sides of the chassis between each row of cleats; for the scrapers to be made of a spring steel; and for there to be means to restrict the height to which the chassis can be lifted by a boom.

### BRIEF DESCRIPTION OF THE DRAWINGS

One embodiment of the invention will be described, example only, with reference to the drawings in which:

FIG. 1 is a part sectional side elevation of a refuse compactor;

FIG. 2 is a part sectional plan view of the refuse compactor in FIG. 1;

FIG. 3 is a front elevation of the stabiliser mechanism on the refuse compactor in FIG. 1; and

FIG. 4 is an elevation of the refuse compactor in FIG. 1 secured to a front-end loader.

### DETAILED DESCRIPTION OF THE DRAWINGS

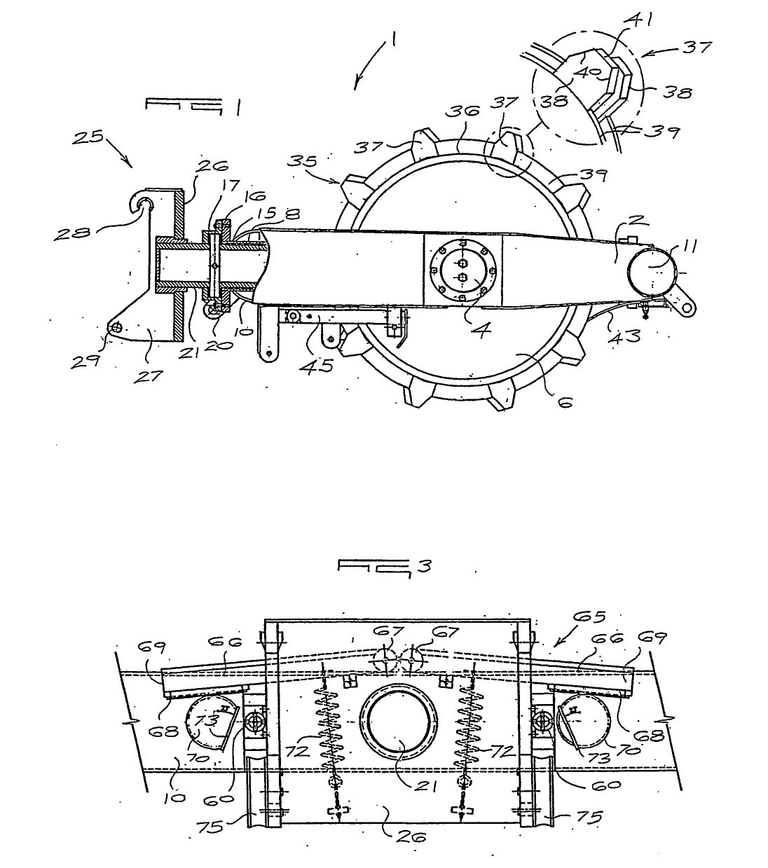

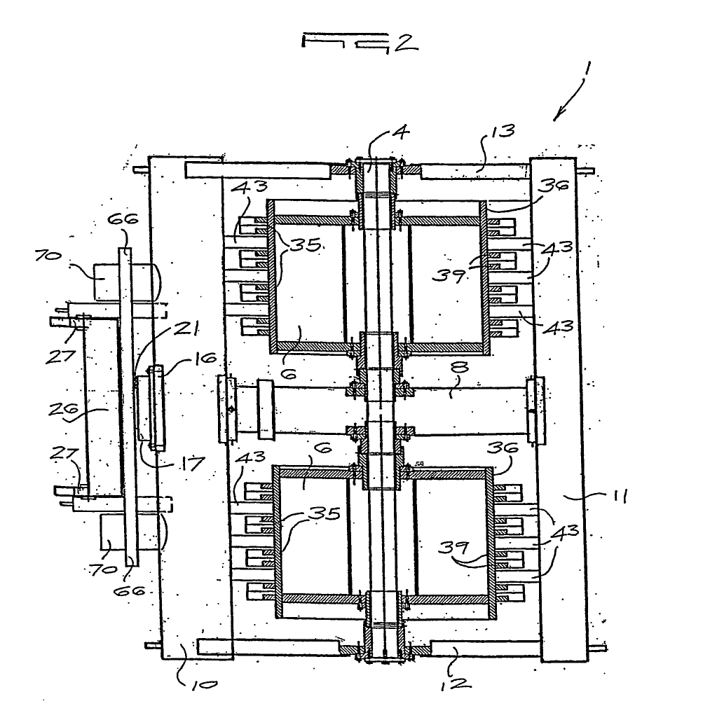

A refuse compactor (1) is shown in FIGS. 1 and 2 and includes a rectangular chassis (2) with an axle (4) secured centrally in the length thereof. A pair of rollers (6) are independently rotatably secured to the axle (4). A shaft (8) extends across the width of the chassis (2) intermediate the rollers (6) and provides a support through which the axle (4) is secured.

The longer sides (10, 11) of the chassis (2) are formed from large diameter steel tubing and joined together at their ends by channel sections (12, 13). One end (15) of the shaft (8) extends through the side (10) of the chassis (2) and terminates in a flange (16). A collar (17) of similar external and internal diameter to the flange (16) but axially stepped along its length is secured to the flange (16). A disc (20) is rotatably secured between the collar (17) and flange (16) by a bearing assembly (not shown). A tubular stem (21) extends through the collar (17) and is secured to the disc (20). The free end of the stem (21) is secured to a coupling (25) which is thus rotatable with respect to the chassis (2).

Each roller (6) has four equally spaced, circumferential rows of cleats (35) on its outer surface (36). As illustrated more clearly in the inset, each cleat (37) is formed from two halves (38) each of which extends from a circumferential flange (39) on the roller (6). The halves (38) each have the same shape, being elongate plates with the edges (40) tapered inwardly from the flange (39) to a flat end (41), but are offset from each other along the circumference of the roller (6).

Three elongate, spring steel scrapers (43) are secured on each side (10, 11) of the chassis (2) adjacent each roller (6) to extend between the rows of cleats (35).

A support leg (45) is secured to the lower side of the channel section (12) adjacent the side (10) and is movable between a stowed condition (as shown) in which it extends along the side of the channel section (12), and an operative condition in which it extends normally to the channel section (12) and supports the coupling (25) above the ground.

As illustrated more clearly in FIG. 4, the coupling (25) is configured to be removably secured to the boom (50) of a front-end loader (51). These booms (50) are usually constructed to provide convenient fitting or removal of buckets, fork equipment material handling arms, timber grapples, snow blades and the like. In this embodiment, the coupling (25) includes a plate-like base (26) secured centrally on one side to the stem (21) with a pair of side plates (27) extending normally from the opposite side at each end thereof. The upper end of each side plate (27) forms a hook (28) along its free edge while the lower end projects outwardly and has an aperture (29) therethrough for receiving a pin (not shown). The hook (28) and aperture (29) co-operate with complementary formations on the boom (50) in known fashion.

In use, the refuse compactor (1) is easily be fitted to the boom (50) of a front-end loader (1) enabling it to be easily manoeuvred. It also provides for efficient compaction of refuse when a number of initial runs are made over the refuse with the boom in a “free float” condition. In this condition the compactor (1) is free to follow the contours of the refuse with no pressure being inserted by the front-end loader (51). The rotatability of the chassis (2) with respect to the coupling (25) further enhances the ability of the compactor (1) to follow contours. During the initial runs the refuse is subjected to shearing and settling. Hereafter the boom (50) can be operated to exert downward force on the compactor (1) to the extent that the compactive effort can be increased to the point where it equals or exceeds that of most self-propelled refuse compactors currently available.

The shape of the cleats (37) has been found to be particularly effective as the offset configuration of the two halves (38) of each cleat (37) provides a large periphery to each cleat (37) and more edges along which shearing can occur. Also, offsetting the two halves (38) provides each cleat (37) with a long, narrow tread providing higher pressure for a longer period of time through the cleat (37). The cleats (37) have been found to be more effective than conventional designs which tend to be limited by the necessity for the cleat to provide traction to a wheel.

The scrapers (43) have also been found to provide superior performance over conventional scrapers which tend to be rigid. The nature of the scrapers (23) of the current invention allows them to flex rather than break where particularly hard material is encountered between the flanges (39).

As the flanges (39) of each row of cleats (35) are spaced apart dirt and other matter tends to collect between them. This proves favourable as the dirt enhances the structural integrity of the flanges (39) while also providing good resistance against wear.

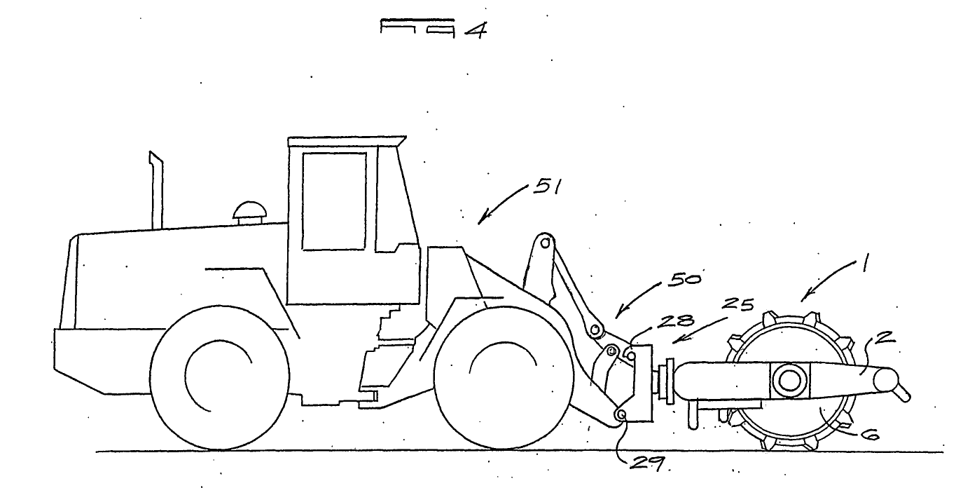

A further advantage of the compactor (1) is that it may be lifted when being transported over roads or other areas not requiring compaction. This virtually eliminates the damage caused to roads by conventional equipment. Lifting the compactor (1) does however have the disadvantage that the compactor (1) tends to rotate with respect to the coupling (25) where one of the rollers (6) has more refuse impacted thereon than the other. This can cause instability during transport, especially when travelling on slopes. Referring also to FIG. 3, a pair of locking pins (60) are provided on either side of the base (26). During use of the compactor (1) the pins (60) are held retracted against a bias in a housing. When released from the retracted position, the pins (60) engage in apertures in the side (10) of the chassis (2) and prevent rotation of the chassis (2) with respect to the coupling (25).

It is, however, not always convenient to lock the chassis (2) and coupling (25) together using the pins (60), for example where the compactor (1) is frequently lifted and moved short distances. A stabiliser mechanism (65) is thus provided between the coupling (25) and chassis (2) and includes a pair of arms (66) pivotally secured at one end (67) to the base (26) above the stem (21) (as shown in FIGS. 2 and 3). A low friction pad (68) is secured to the lower most side of each arm (66) adjacent the free end (69) thereof. Each pad (68) rides on a part circular stop (70) extending from the side (10) of the chassis (2) on opposite sides of the shaft (8). A coil spring (72) is secured between each arm (66) and the base (26) to provide a bias on each arm (66) towards its respective stop (70). Furthermore, each stop (70) extends a sufficient distance from the side (10) to engage the base (26) when it is rotated sufficiently with respect to the chassis (2). Each stop (70) is provided with a flat surface (73) configured to abut against a rubber pad (75) on each side of the base (26) with the base (26) rotated into contact with the stop (70). The stops (70) thus limit the degree rotation of the coupling (25) with respect to the chassis (2).

In use, the arms (66) act on the chassis (2) to provide a bias opposite to the direction of rotation about the stem (21). It will be appreciated that rotation of the chassis (2) in the direction of one of the arms (66) will cause the other arm (66) to be raised and to extend the spring (72) to which it is secured whilst the other spring (72). The spring (72) being expanded will exert a greater force on the arm (66) to which it is secured them the other spring (72) and hence bias the chassis (2) in the direction opposite to its rotation. A stabilising effect against rotation of the chassis (2) with respect to the coupling (25) is thus produced with the stops (70) limiting the degree of overall rotation.

The stabiliser mechanism (65) has been found to be highly effective with the springs (72) providing up to about 400 kilograms of torsional load each. It is envisaged, however, that dampers may be added to the springs.

To improve the stability of the front-end loader and compactor during transport, the hydraulic system that actuates the front-end loader bucket “roll back” is used to roll back the compactor. This greatly reduces the compactor mass overhang, that is the distance between the centre of the compactor mass and the front-end loader front axle.

From the drawings it will be noted that all the structural and wear parts of the compactor are of abnormal proportion when compared to conventional towed compactors. This abnormal design is required to withstand the extremely high shock loads and forces that are experienced when the compactor is operated on refuse sites with maximum front-end loader mass transfer to the compactor as it is possible that the entire mass on the front axle of the front-end loader can be transferred to the compactor.

A highly effective yet relatively cheaply manufactured refuse compactor is thus provided. It is envisaged that the compactor will satisfy a need in countries varying from the First to the Third World with demand from First World countries in fact being far greater than that from Third World countries. It will be appreciated, however, that many other embodiments of a refuse compactor exist which fall within the scope of the invention particularly as regards the configuration thereof. For example, means can be provided to restrict the height to which the compactor can be lifted above the ground by a front-end loader. The coupling of the compactor can clearly be configured to provide a complementary fit with any suitable front-end loader. Also, any number of rollers could be used with any suitable cleat configuration.

1. A refuse compactor comprising at least one roller secured to a chassis characterised in that the chassis has a coupling for releasably securing the chassis to a boom of a front-end loader.

2. A compactor as claimed in claim 1 in which a pair of independently rotatable rollers are secured to the chassis.

3. A compactor as claimed in claim 2 in which the rollers are secured to a central axle.

4. A compactor as claimed in claim 1 in which the or each roller has a plurality of cleats thereon.

5. A compactor as claimed in claim 4 in which the cleats are formed in rows about the circumference of the or each roller.

6. A compactor as claimed in claim 4 in which each cleat is formed from two halves offset from each other along a circumference of the roller.

7. A compactor as claimed in claim 6 in which the edges of half of each cleat taper to a flat end.

8. A compactor as claimed in claim 6 in which half of each cleat extends from a circumferential flange on the roller.

9. A compactor as claimed in claim 8 in which the flanges are spaced apart.

10. A compactor as claimed in claim 1 in which the chassis is at least partly rotatable with respect to the coupling.

11. A compactor as claimed in claim 10 in which the coupling is rotatably secured to a shaft extending across the chassis intermediate the rollers.

12. A compactor as claimed in claim 11 in which a stabiliser mechanism restricts rotation of the chassis with respect to the coupling.

13. A compactor as claimed in claim 12 in which the stabiliser mechanism provides a downward bias on the chassis on either side of the shaft.

14. A compactor as claimed in claim 12 in which the stabiliser mechanism provides stops to limit the extent of rotation of the chassis with respect to the coupling.

15. A compactor as claimed in claim 12 in which the stabiliser mechanism includes at least one lock to secure the chassis and coupling against relative motion.

16. A compactor as claimed in claim 5 in which at least one scraper extends from the chassis between each row of cleats on the or each roller.

17. A compactor as claimed in claim 16 in which a pair of scrapers extends from opposite sides of the chassis between each row of cleats.

18. A compactor as claimed in claim 17 in which the scrapers are made of a spring steel.

19. A compactor as claimed in claim 1 in which there is a means to restrict the height to which the chassis can be lifted by a boom.

20. A cleat for a roller characterised in that the cleat is formed from two halves offset from each other along a circumference of the roller.

21. A cleat as claimed in claim 20 in which the edges of each half of each cleat taper to a flat end.

22. A cleat as claimed in claim 20 in which each half of each cleat extends from a circumferential flange on the roller.

23.-24. (canceled)
